(19) United States
(12) Patent Application Publication
(10) Pub. No.: US 2010/0205556 A1
(43) Pub. Date: Aug. 12, 2010

(54) HUMAN MACHINE INTERFACE NAVIGATION TOOL

(75) Inventors: Karsten Madsen, Hvidovre (DK); Peter Blomberg, Hollviken (SE)

Correspondence Address: MICHAUD-Kinney Group LLP, 306 INDUSTRIAL PARK ROAD, SUITE 206, MIDDLETOWN, CT, 06457, US

(73) Assignee: Alfa Laval Corporate AB, Lund (SE)

(21) Appl. No.: 12/368,332

(22) Filed: Feb. 10, 2009

(51) Int. Cl. G06F 3/048

(52) U.S. Cl. 715/777

(57) ABSTRACT

In a method for human machine interface navigation, a controller is in communication with an electronic display. The controller is programmed to cause a navigation tool to appear on the display. The navigation tool includes an overview window exhibiting a plurality of selectable main and sub tabs. Upon selection of a sub tab, a parameter screen is displayed. A parameter screen corresponding to a last selected sub tab is exhibited upon selection of an associated main tab.

### FIELD OF THE INVENTION

The present invention is generally directed to Human Machine Interfaces (HMIs) and is more particularly directed to a tool for navigating an HMI.

### BACKGROUND OF THE INVENTION

The use of HMIs often necessitates accessing many different display screens in order to operate and monitor equipment, as well as evaluate process operation and performance. Navigating back and forth between these display screens can be confusing and time consuming. Where real time decisions are needed, the daunting task of obtaining needed information in a timely manner can prove difficult at best and has the potential for allowing costly or even dangerous situations to go unnoticed and therefore unremedied for periods of time.

### SUMMARY OF THE INVENTION

The present invention resides in one aspect in a method for human machine interface navigation wherein a controller is provided and is in communication with an electronic display. The controller has software programming associated therewith such that the software programming and the controller are cooperable with one another to cause a human machine interface navigation tool to be exhibited on the electronic display. The navigation tool includes an overview window having a plurality of selectable main tabs and a plurality of selectable sub tabs exhibited on the electronic display. Portions of the plurality of selectable sub tabs are associated with each of the main tabs. Each of the main tabs and the sub tabs can be selected by a user, thereby causing, among other things, the selected main tab and the associated sub tabs to be exhibited on the electronic display. Upon selection of one of the sub tabs, the controller and the software programming cooperate to cause a parameter screen associated with the selected sub tab to be exhibited on the electronic display. The HMI and thereby the navigation tool is operable such that if a sub tab had been previously selected, selecting the main tab with which the previously selected sub tab is associated, will cause the parameter screen associated with the last of the previously selected sub tabs to be exhibited on the electronic display.

Preferably, any one of the parameter screens can be reached by selecting a maximum of two tabs chosen from the main and sub tabs. In addition, it is also preferable that the sub tabs exhibited on the system overview window represent a totality of the parameter screens that comprise the human machine interface.

In an embodiment of the present invention, the main tabs and the sub tabs are arranged on the overview screen in a matrix-like array. The array is arranged as a grid display, each column of the grid being headed by one of the main tabs, the remainder of each column comprising a portion of the sub tabs, each of which is related to the main tab heading the column.

While the array has been described as having the main tabs head columns with associated sub tabs extending in a column below the main tabs, the present invention is not limited in this regard as the main and sub tabs can be arranged in different orders without departing from the broader aspects of the invention.

The present invention resides in another aspect in a computer system having an electronic display screen. The computer system includes a human machine interface navigation tool comprising a controller and a system overview window having a plurality of main tabs and a plurality of sub tabs exhibited thereon. Portions of the sub tabs are associated with each of the main tabs. Selection means are provided for choosing at least one of the main tabs and the sub tabs. Software is associated with the computer system and cooperable with the controller. The software is operable to cause a parameter screen corresponding to one of the sub tabs to be displayed upon selection of the sub tab. The software is operable so that selection of one of the main tabs wherein a sub tab associated therewith had previously been selected, causes the parameter screen corresponding to a last selected one of the sub tabs associated with the main tab, to be displayed.

### BRIEF DESCRIPTION OF THE DRAWINGS

FIG. 1 schematically illustrates a portion of a process coupled to a human machine interface using the navigation tool of the present invention.

FIG. 2 shows an overview screen of the navigation tool of the present invention.

FIG. 3 shows a parameter screen of the navigation tool illustrating the portion of the process shown in FIG. 1.

FIG. 4 illustrates faceplate screens for monitoring and/or controlling various machine or process operations.

FIG. 5 illustrates a parameter screen employing an analog type display.

FIG. 6 illustrates a parameter screen showing a digital display.

FIG. 7 illustrates a parameter screen for setting up a process.

FIG. 8 illustrates a parameter screen for performing calculations.

FIG. 9 illustrates a parameter screen for language selection.

FIG. 10 illustrates a parameter screen showing a trend graph.

FIG. 11 illustrates a parameter screen showing a trend graph.

### DETAILED DESCRIPTION OF THE PREFERRED EMBODIMENTS

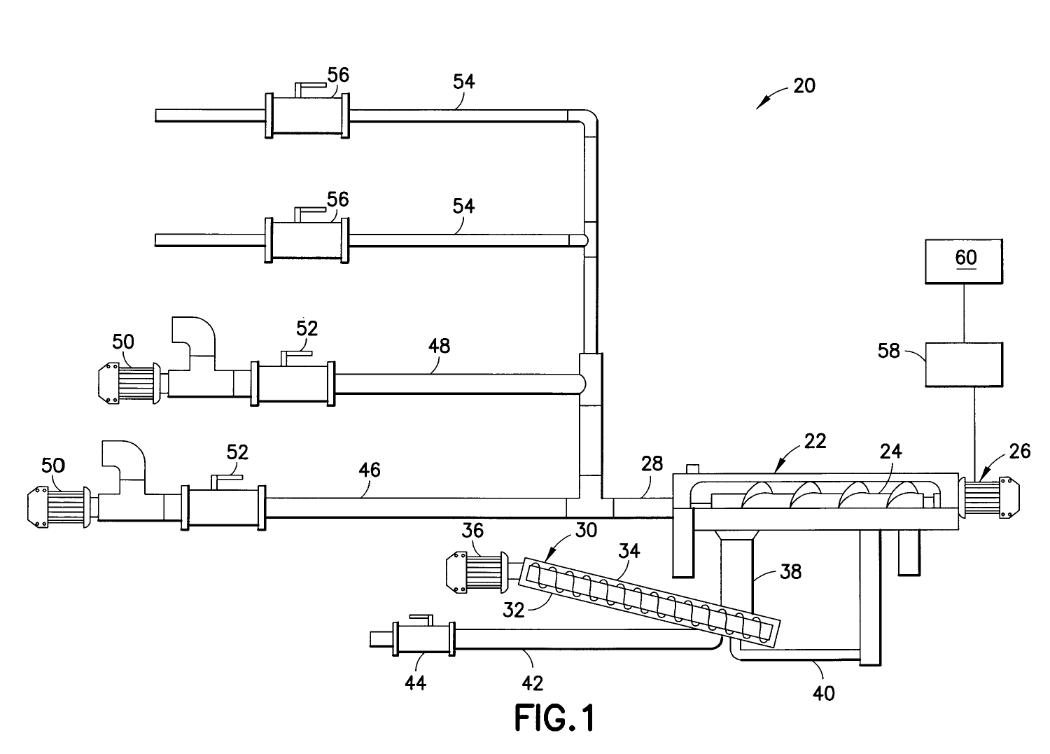

As shown in FIG. 1, a portion of a process generally designated by the reference number 20 includes a decanter-type centrifuge 22. While the particular process 20 is shown and described herein, it is for illustrative purposes only as the HMI and navigation tool (described in detail below) can be used with any suitable process or in connection with any device or operation whereby multiple inputs and/or devices are monitored and/or controlled.

Still referring to FIG. 1, the decanter-type centrifuge 22 includes a rotor 24 coupled for rotation to a motor 26. The centrifuge is also coupled to a network of conduits (described in detail below) by a main conduit 28. An auger-type conveying device generally designated by the reference number 30 is in fluid communication with the centrifuge 22 and includes an auger 32 positioned in a housing 34. The auger 32 is rotatably coupled to a motor 36. The conveying device 30 is in fluid communication with the centrifuge 22 via conduits 38 and 40 for receiving effluent therefrom. A diverting flush line 42 is also in fluid communication with the conveying device 30. The diverting flush line 42 has a valve 44 coupled thereto and moveable between an open and a closed position.

The above-described network of conduits include a pair of feed lines 46 and 48, each having a pump 50 and valve 52 attached thereto. A pair of flush lines 54 are also part of the network of conduits with each flush line having a valve 56 attached thereto. Each of the valves 52 and 56 are moveable between an open and a closed position.

Still referring to FIG. 1, a controller 58 is in communication with and is used to operate and/or monitor various aspects of the process 20. The controller 58 is programmed to monitor and receive signals indicative of various operating parameters of the process 20. For example, each of the valves 44, 52 and 56 can include sensors and/or actuators thereon that provide information to the controller 58 to monitor and/or control the position of each valve, e.g. open, closed or a position between open and closed. Likewise the operating speed of the motors 26 and 36 can be monitored and/or controlled by the controller 58. Various sensors (not shown) can also communicate with the controller 58 to provide information such as, for example, vibration of the centrifuge 22, flow through the network of conduits, temperatures, pressures and the like.

The controller 58 is in communication with an electronic display 60. The controller 58 is programmed with human machine interface (HMI) software. A navigation tool, explained in greater detail below, forms at least a portion of the HMI software. While a single controller 58 is shown in FIG. 1, the present invention is not limited in this regard as more than one controller can be employed without departing from the broader aspects of the present invention. Moreover, the term “controller” should be broadly construed to mean a programmable logic controller (PLC), a computer (laptop or desktop) or other types of controllers known to those skilled in the pertinent art to which the present invention pertains. Where multiple controllers are used, the inputs of the various controllers can be received by a main controller, the main controller being programmed with the HMI and navigation tool software.

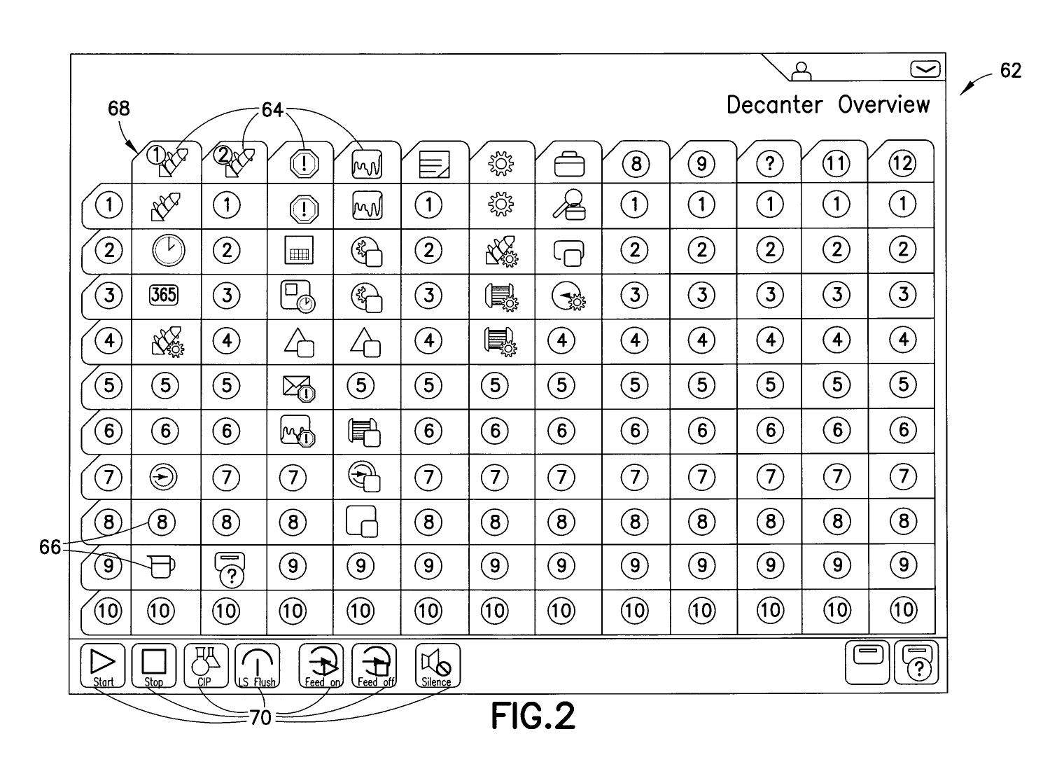

As shown in FIG. 2, the navigation tool includes an overview screen, generally designated by the reference number 62. The overview screen 62 includes a plurality of selectable main tabs 64 and sub tabs 66 arranged in a matrix-like array of rows and columns. The main tabs 64 in the illustrated embodiment extend across the top row of the matrix-like array. The sub tabs 66 extend in columns below the main tabs 64. Similar to the main tabs 64, each of the sub tabs 66 is selectable by a user of the navigation tool. The sub tabs 66 in each column are related to the main tab 64 heading the column. While the main tabs 64 have been shown and described as heading each column in the above-described array, the present invention is not limited in this regard as the main tabs could be at the bottom of each column or the beginning or end of each row or in any other suitable location.

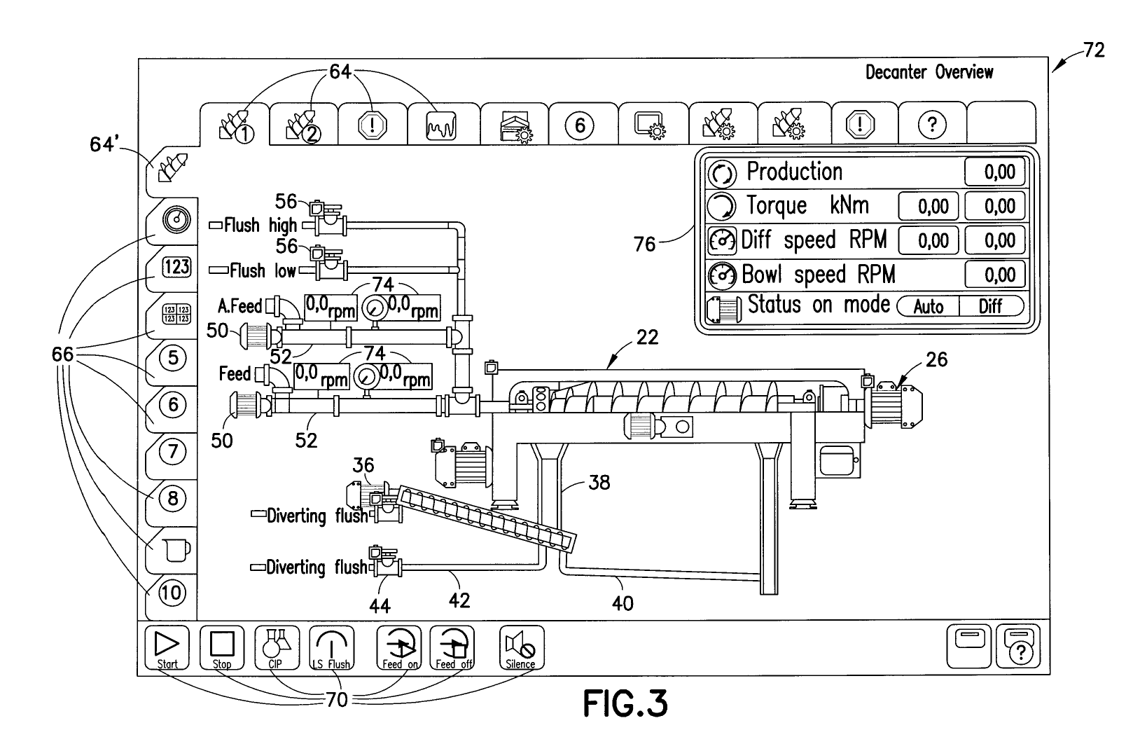

In the illustrated embodiment, the sub tabs 66 in each column are related to the main tabs 64 heading the column. For example, the column 68 in FIG. 2 includes a main tab 64 illustrative of the decanter-type centrifuge 22, FIG. 1. Each sub tab 66 under that main tab 64 in column 68 is related to the centrifuge 22. Selecting one of the sub tabs 66 will cause the navigation tool and thereby the HMI to display a parameter screen, an example of which is shown in FIG. 3. Accordingly, the navigation tool, via the overview screen 62, allows a user to access from that one screen the totality of the parameter screens relevant to the particular HMI. The HMI can pertain to a single machine, an entire process or a portion of a process. Regardless, all of the screens forming the particular HMI can be accessed from the overview screen 62 of the navigation tool. In this manner, a user does not have to scroll through a myriad of parameter screens in order to get to the desired screen.

The above-described navigation tool is operable so that a user can access any desired parameter screen by selecting a maximum of two tabs chosen from the main and sub tabs, 64 and 66, respectively. For example, selection of one of the main tabs 64 can cause the sub tabs 66 that are related thereto to be displayed or highlighted on the display screen. Selection of a sub tab 66 indicative of a desired parameter screen will result in that parameter screen being displayed. Moreover, the navigation tool is operable so that selection of a main tab 64 corresponding to a column where a sub tab 66 had been previously selected, will cause a parameter screen corresponding to the last selected sub tab in that column to be exhibited on the electronic display 60, FIG. 1.

Selection of the main or sub tabs, 64 and 66, respectively, can be accomplished in any one of a number of ways depending on the type of display and equipment used in accessing and operating the HMI and thereby the navigation tool. For example, the electronic display 60, FIG. 1, can incorporate a touch screen so that a user need only touch the screen over the desired tab to select it. A mouse and keyboard (not shown) can also be employed as can a track ball, touch pad or any other type of point and select device known to those skilled in the pertinent art to which the present invention pertains.

Referring back to FIG. 2, the overview screen 62 as well as the parameter screens FIGS. 3-11, each include selectable control tabs 70, shown in the illustrated embodiment along a lower left hand portion of the overview or parameter screens. These selectable control tabs 70, upon selection by a user, can operate various elements of a process or machine. For example, they could be used to start or stop the centrifuge 22, open or close the valves 44, 52 and 56, operate pumps or motors, and the like. Each control tab 70 can also be programmed so that selection thereof causes a series of operations to be performed. While the selectable control tabs 70 in the illustrated embodiments have been shown and described as being positioned in the lower left of the overview and parameter screens, the present invention is not limited in this regard as the selectable control tabs can be positioned in virtually any location on the screens without departing from the broader aspects of the present invention. Moreover, the selectable control tabs can appear on each of the overview and parameter screens or on a portion thereof.

The HMI and the navigation tool described herein can require security protocols to be entered in order to gain access to the navigation tool. These security protocols can take the form of usernames and passwords, biometric devices such as, but not limited to, voice recognition, fingerprint and/or retinal scanners, card swipes, keys, and combinations thereof. In addition, other types of security protocols known to those skilled in the pertinent art to which the present invention pertains can also be employed. Moreover, depending on the navigation tool and what it monitors and controls, different levels of security can be provided, allowing users access to only those parameter screens commensurate with their assigned security level or clearance.

Referring back to FIG. 3, the parameter screen 72 depicted therein is representative of the process 20 shown in FIG. 1. Access is gained to the parameter screen 72 via selection of one of the sub tabs 66 or a main tab 64 relevant to the sub tab 66 where, as described above, the sub tab corresponding to the parameter screen 72 was the last selected sub tab. The main tabs 64 are shown extending across an upper portion of the parameter screen 72. The main tab 64′ corresponding to the group of sub tabs 66 from which access was gained to the parameter screen 72 is shown on the upper left side of the parameter screen. The sub tabs 66 corresponding to the main tab 64′ extend down the left hand side of the parameter screen 72.

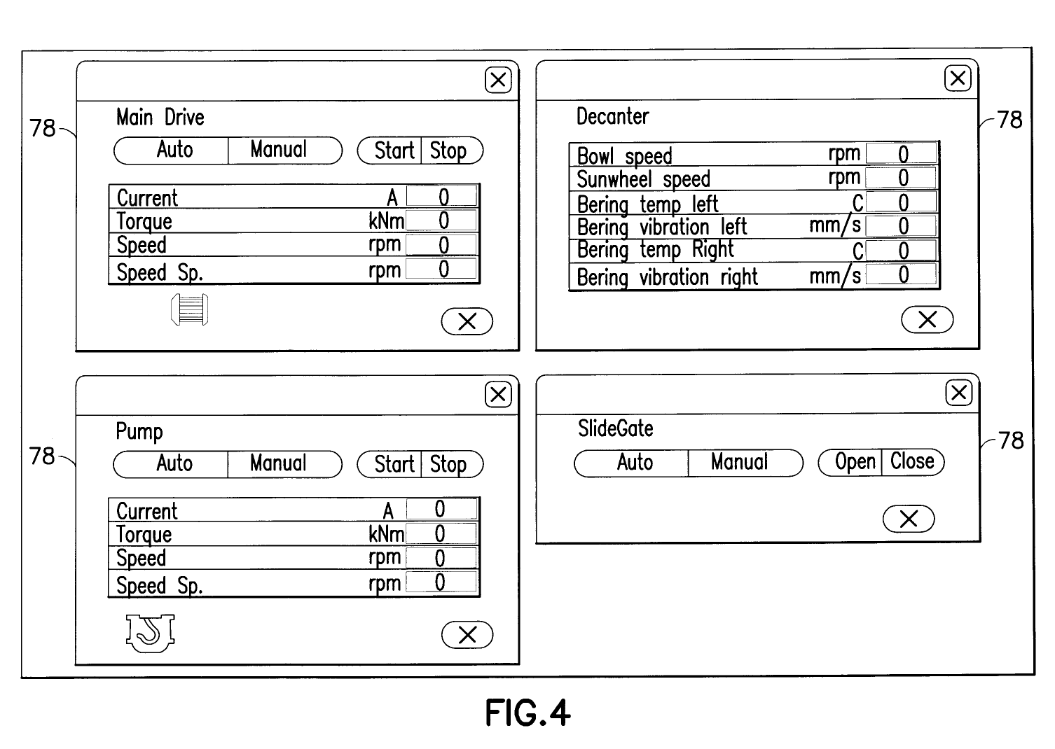

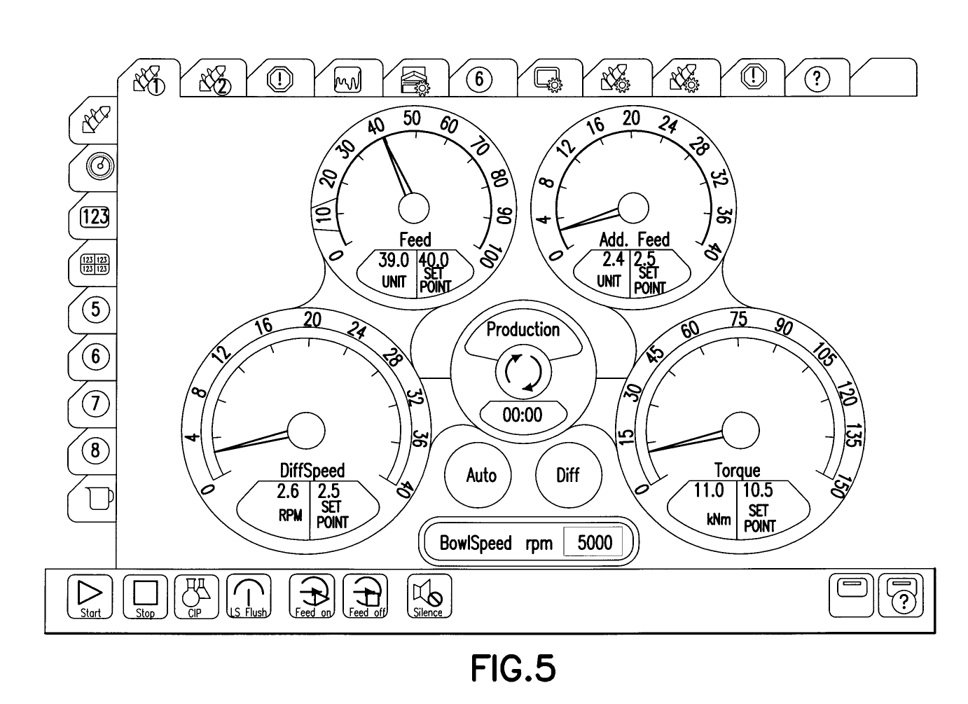

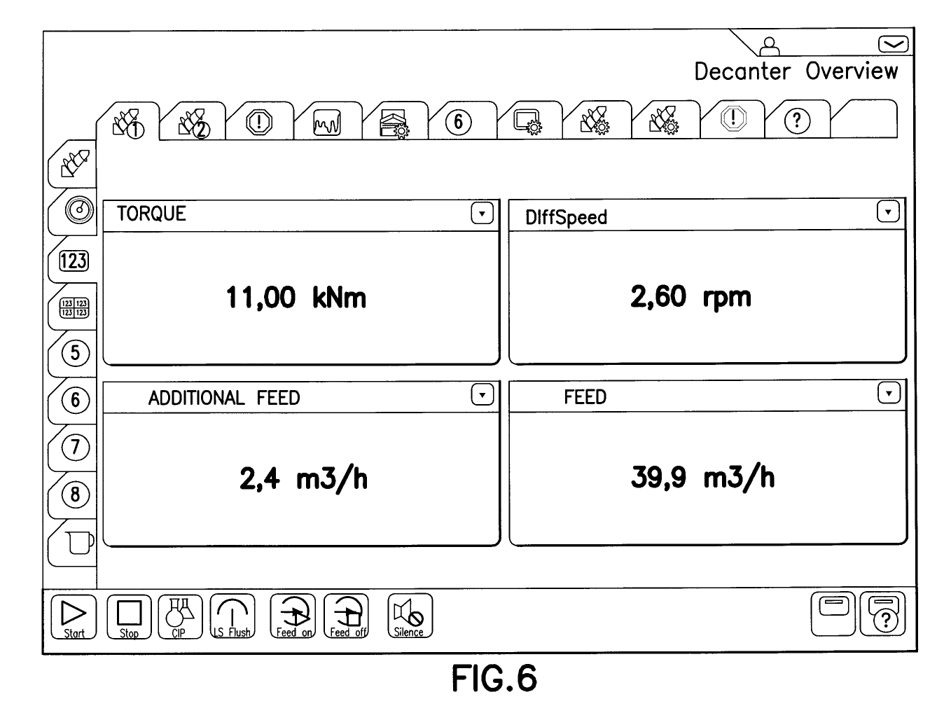

A monitor screen 76 indicating operating parameters of the centrifuge 22 is positioned on the parameter screen 72. A series of selectable faceplates 74 are also shown on the parameter screen 72. Upon selection of a faceplate 74 on the parameter screen 72, a monitor screen 78 similar to those shown in FIG. 4 can be accessed. The monitor screens 78 can appear as a separate screen or they can appear on the appropriate parameter screen similar to the monitor screen 76 shown in FIG. 3. As shown in FIGS. 5 and 6, the parameter screens, depending upon selections made by a user, can employ an analog or digital display.

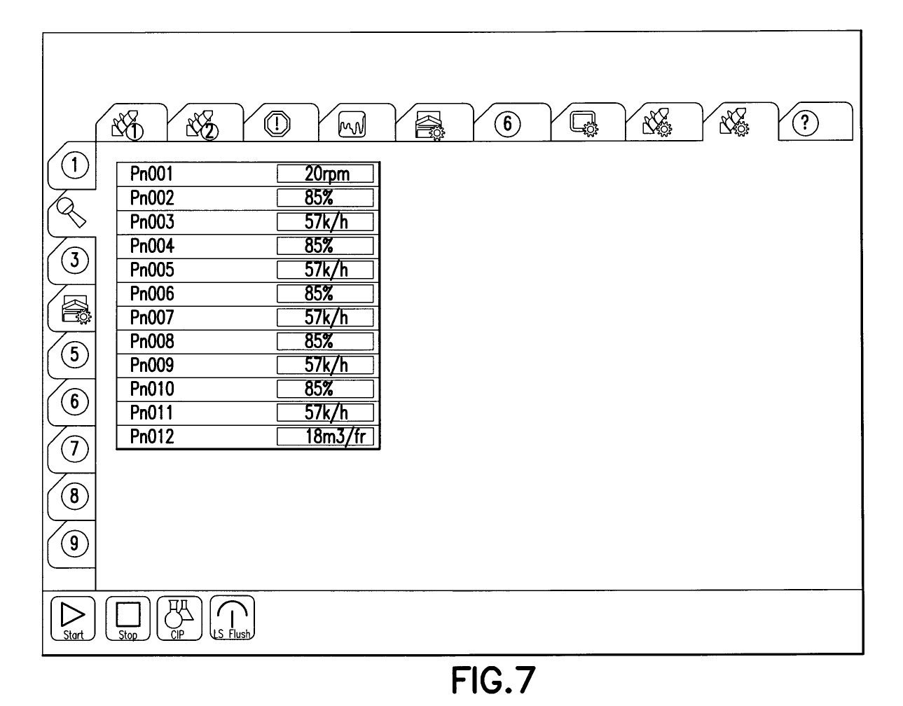

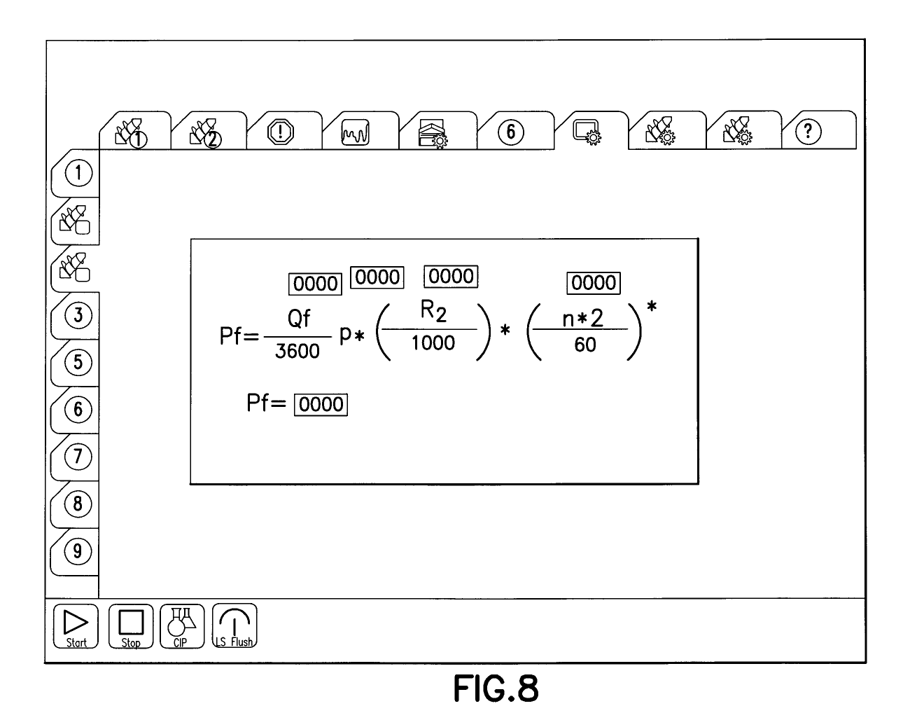

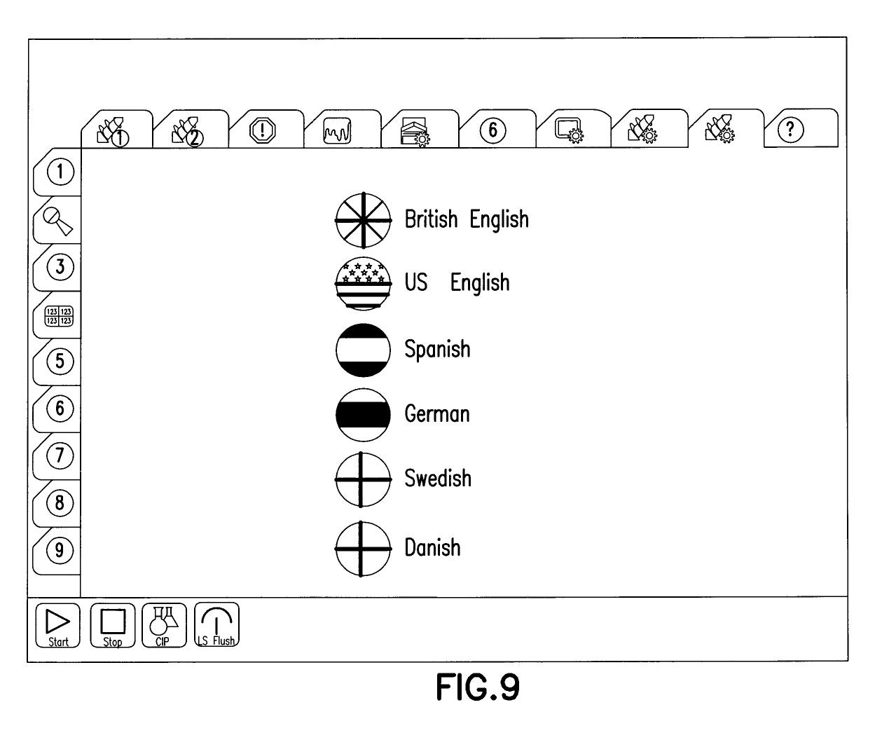

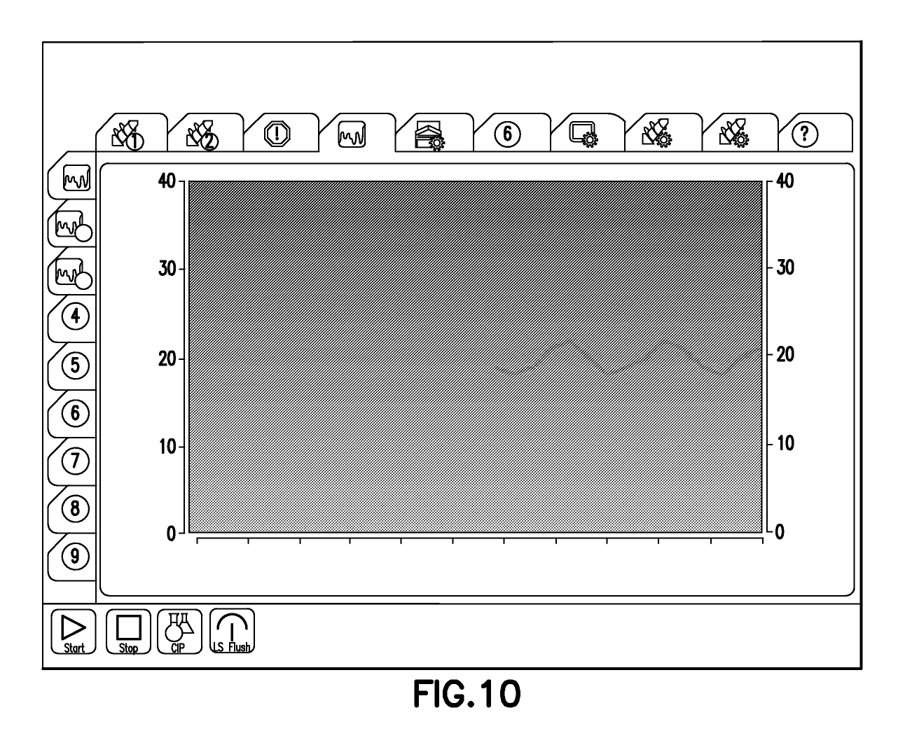

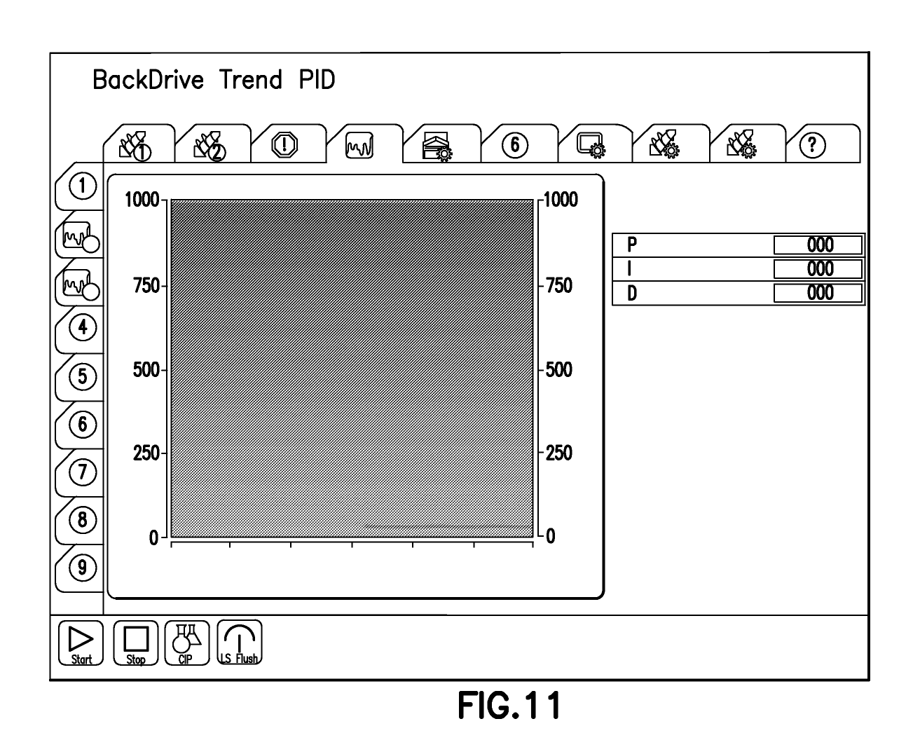

FIGS. 7-11 depict various different parameter screens a user may select by choosing the appropriate main or sub tabs, 64 and 66, respectively. For example, the parameter screen shown in FIG. 8 allows a user to perform calculations 80 depending upon the particular process, machine, or the like that the HMI and navigation tool is utilized with. FIG. 9 illustrates a parameter screen wherein a user can select a desired language to work in. FIGS. 10 and 11 illustrate parameter screens whereby graphical historical data is shown relevant to whatever the HMI is utilized with.

The HMI and navigation tool described herein can also be configured to allow a user to access the internet. Internet access can be employed to allow the user to search, go to equipment makers' websites, send e-mail messages, etc. In addition, the HMI and navigation tool can also be configured to allow a user to access equipment manuals and other types of instructions. These manuals and/or instructions can be stored in the memory of a computer or controller accessible using the HMI, or the manuals and/or instructions can be accessed via the internet.

Although this invention has been shown and described with respect to the detailed embodiments thereof, it will be understood by those of skill in the art that various changes may be made and equivalents may be substituted for elements and steps thereof without departing from the scope of the invention. In addition, modifications may be made to adapt a particular situation to the teachings of the invention without departing from the essential scope thereof. Therefore, it is intended that the invention not be limited to the particular embodiments disclosed in the above detailed description, but that the invention will include all embodiments falling within the scope of the above description.

What is claimed is:

1. A method for human machine interface navigation comprising:
providing an electronic display;
providing a controller in communication with said electronic display, said controller having software programming associated therewith, said controller and said software programming being cooperable with one another to cause a human machine interface navigation tool to be displayed on said electronic display;
said navigation tool comprising;
an overview window including a plurality of main tabs exhibited on said electronic display, and a plurality of sub tabs exhibited on said electronic display, portions of said sub tabs being associated with each of said main tabs,
each of said main tabs and said sub tabs being selectable by a user; said method further comprising;
choosing one of said main tabs or said sub tabs;
upon selection of one of said main tabs, said sub tabs associated therewith are exhibited on said electronic display;
upon selection of one of said sub tabs said control and said software programming cooperate to cause a parameter screen exhibited on said electronic display; and wherein
a parameter screen corresponding to a last selected one of said sub tabs is exhibited on said electronic display upon selection of the main tab to which said last selected sub tab is related.

2. A method as defined by claim 1 wherein said plurality of main tabs and said plurality of sub tabs exhibited on said electronic display in said system overview window are representative of a totality of the parameter screens forming said human machine interface.

3. A method as defined by claim 2 wherein said plurality of main tabs and said plurality of sub tabs are arranged on said system overview window in a matrix.

4. A method as defined by claim 1 wherein any one of said parameter screens can be reached by selecting a maximum of two tabs chosen from said main and sub tabs.

5. A method as defined by claim 3 wherein said matrix is arranged as a grid display, each column of said grid being headed by one of said main tabs, the remainder of said column comprising a portion of said sub tabs, each of said portion of said sub tabs being related to said main tab heading said column.

6. A method as defined by claim 1 wherein at least a portion of said parameter screens include selectable icons, that upon selection by a user are operable to change operational parameters of components monitorable via said navigation tool.

7. A method as defined by claim 1 wherein said navigation tool is in communication with the internet, thereby allowing a user to selectively access information relevant to one of parameters, equipment and components monitorable using said navigation tool.

8. A method as defined by claim 1 wherein said navigation tool includes means for entering security protocols, said method further comprising:
receiving security protocol information entered by a user, the receipt of which allows said user to access at least a portion of said parameter screens by selecting at least one of said main and sub tabs.

9. A method as defined by claim 1 wherein a selectable manual tab is exhibited on said electronic display, said method further comprising selecting said manual tab, thereby causing a manual corresponding to at least one component monitorable by said navigation tool.

10. In a computer system having a display screen, a human machine interface navigation tool comprising:
a controller;
a system overview window including a plurality of main tabs and a plurality of sub tabs, portions of said sub tabs being associated with each of said main tabs;
selection means for choosing at least one of said main tabs and said sub tabs; and
software associated with said computer system and cooperable with said controller, said software being operable to cause a parameter screen corresponding to one of said sub tabs to be displayed upon selection of said sub tab; and wherein
said software is operable so that selection of one of said main tabs wherein a sub tab associated therewith had previously been selected, causes the parameter screen corresponding to a last selected one of said sub tabs associated with said main tab, to be displayed.

11. A computer system as defined by claim 10 wherein said plurality of main tabs and said plurality of sub tabs are arranged in a matrix on said system overview window, each of said main and sub tabs on said matrix being selectable by a user.

12. A computer system as defined by claim 10 further comprising a database operable with said software, said database storing information therein relevant to said matrix of main tabs and sub tabs.

13. A computer system as defined by claim 10 wherein said software is operable to cause any parameter screen forming part of said human machine interface to be accessible by selection of a maximum of two tabs chosen from said main and sub tabs.

14. A computer system as defined by claim 10 wherein said sub tabs exhibited on said system overview window are representative of a totality of parameter screens that form said human machine interface.
